(19) United States
(12) Patent Application Publication
(10) Pub. No.: US 2002/0056113 A1
(43) Pub. Date: May 9, 2002

(54) Home network connection system

(75) Inventor: Jane Wang, Taipei (TW)

Correspondence Address: DOUGHERTY & TROXELL, SUITE 1404, 5205 LEESBURG PIKE, FALLS CHURCH, VA, 22041, US

(73) Assignee: ULAN CO., LTD.

(21) Appl. No.: 09/725,098

(22) Filed: Nov. 29, 2000

(30) Foreign Application Priority Data
Jul. 4, 2000 (TW) 89113161

(51) Int. Cl. H04N 7/18

(52) U.S. Cl. 725/78

(57) ABSTRACT

A home network connection system is disclosed. A plurality of plug boxes matching with the requirement of the 1394 communication protocol proposed by Institute of Electrical and Electronic Engineers (IEEE) are installed in each of small rooms within a space. Then the electronic or electric devices are connected to the plug boxes through wires. Proper connecting wires serve to connect these plug boxes for transmission. The home audio and video interoperability (HAVI) is used to confine the devices. Therefore, the electronic or electric devices of a home can be connected through the 1394 communication protocol so that the resources in the plug boxes are shared by all members of the home.

### 1. FIELD OF THE INVENTION

The present invention relates to a home network connection system, by a 1394 signal transformation device and the connection of the 1394 signal wires, various 3C (computer, communication and consumer) electronic products are connected as a network. Moreover, a home audio and video interoperability (HAVI) protocol serves to confine these devices. Thereby, the 3C devices can be controlled remotely and resources in these devices can be shared.

### 2. BACKGROUND OF THE INVENTION

With the improvement of communication and network technologies, signals can be transferred between networks. Therefore, many problems in the portion are resolved by novel technologies.

Since the prevail of network technology, information can be transferred between different devices. Therefore, it is possible to integrate various devices through networks. The primary objects to the current technology is to control various 3C (computer, communication and consumer) electronic devices. However, this technology is not mature fully. Most related arts are presented in the technical papers, or in developing. No well commercial product is disclosed.

However, the current communication and network technologies have improved to a level which has the ability to integrate many devices. Another, usually there are many 3C (computer, communication and consumer) electronic devices being placed in different locations of a space (for example in home), for example, a stereo in drawing room and a telephone in living room. Often, this is inconvenient for a user to get these devices in different locations.

In the prior art, the connection of devices for controlling is confined by transmission distance. In application, it is very inconvenient for accessing these devices in different locations. Some ideals by using wireless transmission are provided for solving this problem, but the wireless transmission has a problem of noise which will dramatically deteriorate the quality of communication so that some works can not be work well. Therefore, the Institute of Electrical and Electronic Engineers (IEEE) has proposed a 1394 communication protocol for the wired communication. By combining the plurality of plug boxes and plugs matching to the 1394 communication protocol, various communication systems can be connected well.

### SUMMARY OF THE INVENTION

Accordingly, the primary object of the present invention is to provide a home network connection system. Various 3C (computer, communication and consumer) electronic products are connected through a network. Therefore, all the devices in home can be properly controlled. Furthermore, the 1394 communication protocol is used for mass-transmission and thus the resources in the devices are shared by all peoples.

Preferably, by installing 1394 signal plug boxes in proper places, various 3C electronic products are connected to the 1394 signal plug boxes. Thereby, signal can be transferred bidirectionally.

Preferably, the 1394 signal transformation device is input with a plurality of 1394 signal slots which serves to be connected to a plurality of 1394 signal connecting wires (IEEE 1394 Firewire Performance Cable). Therefore, proper control signals are transferred for driving the various devices.

Preferably, the control process of the 1394 signal is conformed to the home audio and video interoperability (HAVI),

A plurality of plug boxes matching with the requirement of Institute of Electrical and Electronic Engineers (IEEE) are installed in each of small rooms within a space. Then the electronic or electric devices are connected to the plug boxes through wires. Proper connecting wires serve to connect these plug boxes for transmission. The home audio and video interoperability (HAVI) is used to confine the devices. Therefore, the electronic or electric devices in home can be connected through the 1394 communication protocol so that the resources in the plug boxes are shared by all members of the home. The home audio and video interoperability (HAVI) is an industrial standard of consumer's electronic products for communicating electronic devices from different manufacturer, the home network connection system is used independent of initiating systems or central processing units (CPU) or working platforms used in work station.

Preferably, by the home audio and video interoperability, the devices can be controlled in position. The members can control the devices remotely through a computer.

The various objects and advantages of the present invention will be more readily understood from the following detailed description when read in conjunction with the appended drawing.

### BRIEF DESCRIPTION OF THE DRAWINGS

FIG. 1 is a plane schematic view showing one embodiment of the present invention about the connections of the devices in home.

FIG. 2 is a schematic view showing the connection in the embodiment of the present invention.

FIG. 3 is a schematic perspective view of the 1394 signal transformation device in the embodiment of the present invention.

### DETAILED DESCRIPTION OF THE PREFERRED EMBODIMENTS

With the improvement and creation of network technology, the communication connection of a computer to an Internet or a local network is performed through a network technology. The network communication protocol (TCP/IP) has matured despite of the application layer, network layer and substance layer, all which can be performed easily by current technology. The present invention relates to use the prior art network technology. By connection means, all the electronic products in home are connected so that each member of the home may operate the electronic devices easily.

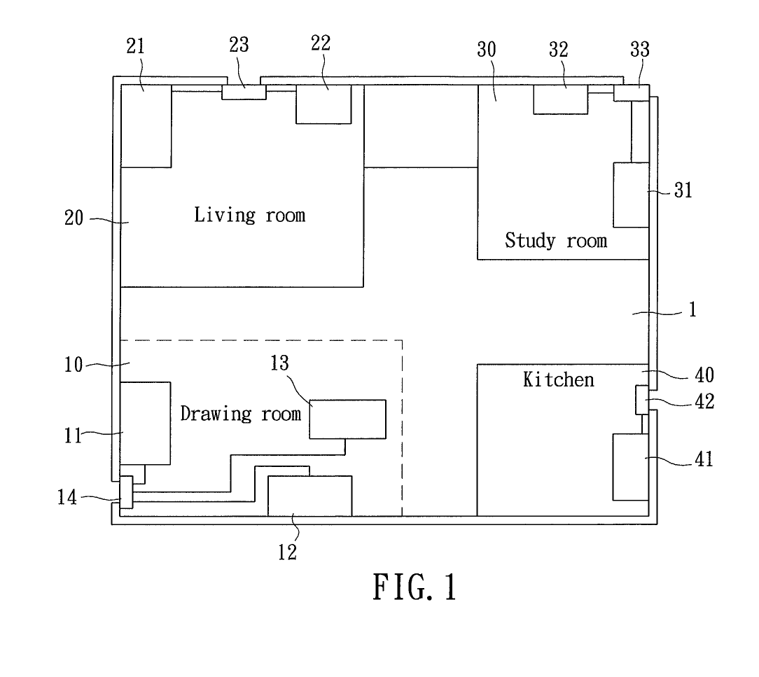

Referring to FIG. 1, a plane schematic view showing one embodiment of the present invention about the connections of the devices in home is illustrated. It is seen from FIG. 1, in general, a home includes a drawing room 10, a living room 20, a study room 30, a kitchen 40, etc. Since the improvement of human life, television (TV) and stereo are popular and are arranged in each room for being used by home members. In this embodiment, it is discovered that the drawing room 10 has a TV screen 11, a stereo 12, a projector 13 and other devices. By installing a first 1394 signal transformation device 14 in a proper position and the various signal connecting wires (for example, USB, RS232, AV, etc), all the electric devices are connected. Furthermore, the living room 20 has a screen 21 and a computer 22. The study room 30 has a computer 31 and a stereo 32. The kitchen 40 has a microwave oven 41. By another second 1394 signal transformation device 23, third 1394 signal transformation device 33 and fourth 1394 signal transformation device 42 to be installed at proper positions of each room, 1394 signal wires serve to connect the first, second, third and fourth plug boxes so as to be formed as a network connecting system. The primary feature of this system is that the whole data is formed as a complete network system, and then through the connection of the 1394 signal transformation devices, all the resources can be enjoyed in common and all the electronic products are connected and are communicated with each other according to the 1394 communication protocol.

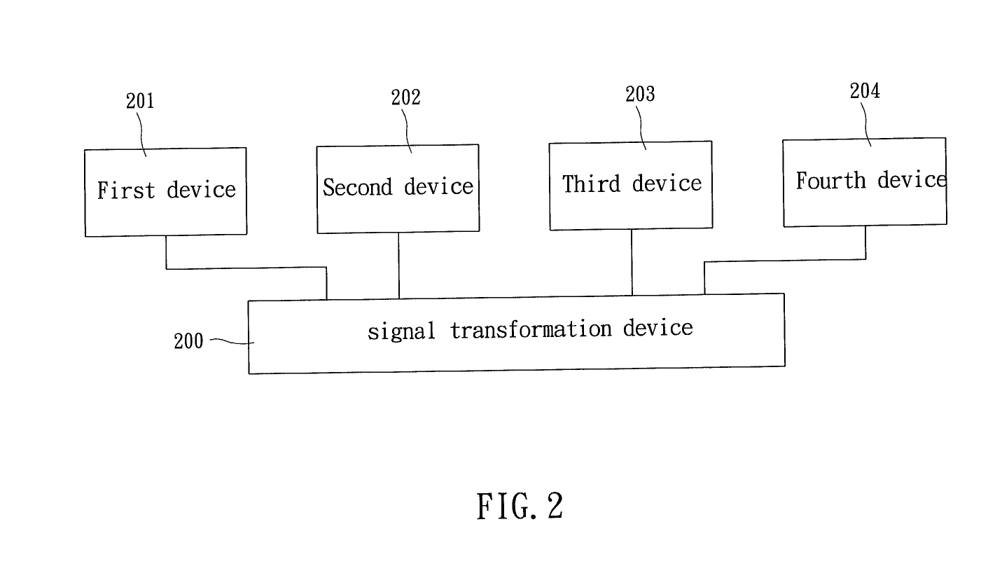

The aforementioned description is only one embodiment about the connection of the home network. In the practical application, all the electric devices can be connected as necessary. With reference to FIG. 2, the connection of above embodiment in the present invention is illustrated, in which a plurality of devices are included. These plurality of devices are not confined in the number thereof. In a proper condition, it is only that the load of the circuit is accepted, the number of the devices can be almost increased unlimitedly within a maximum number of (1023*63=64449) so that the application of this device can be expanded to a building, even a whole community. In above plurality of structure, a first device 201, a second device 202, a third device 203, and a fourth device 204 are connected to a 1394 signal transformation device 200 through proper signal wires. According to the home audio and video interoperability, all electronic products connected to the 1394 signal transformation device through a communication protocol can be programmed for controlling the connected plurality of devices so as to be formed as a network. Thereby, the resources in the network can be performed in common.

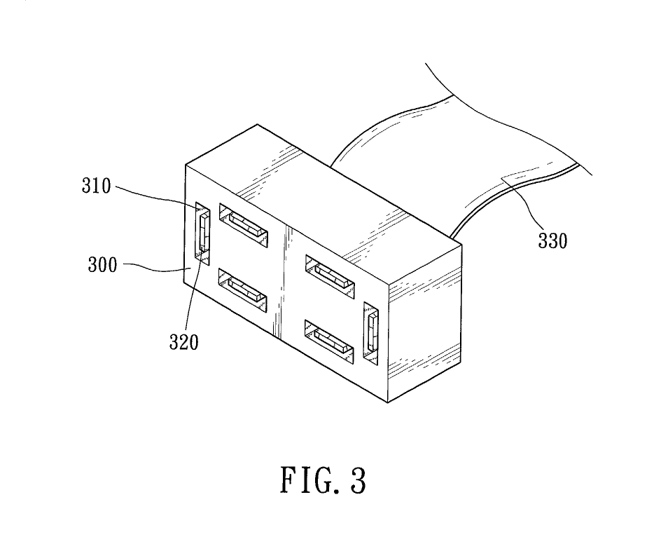

Referring to FIG. 3, a schematic perspective view about a first connector plug box in the embodiment of the present invention is illustrated. The 1394 signal transformation device 300 is installed with a plurality of 1394 signal slots 310. A signal connecting plate 320 is installed for these 1394 signal slots 310. By the installation of these 1394 signal slots 310, the 1394 signal connecting wires can be inserted thereon. Further, by the installation of the 1394 connecting plates 320, proper control signals can be transferred. The 1394 signal transformation devices are connected to other 1394 signal transformation devices through the 1394 signal bank wires 330 so as to be connected with other plug boxes. A wave repeater is further installed in each of the 1394 signal transformation device 300 for enhancing the received signal so as to depress the decaying of signals in transmission.

The detail description of the home network connection system according to the present invention has been made above. In the signal transmission, under the consideration of the signal transmission, the present invention is designed according to the wires and structure related to 1394 signal transmission, while in practical, the application can be designed according to signal connecting wires and plugs of different specification.

The present invention is designed according to Institute of Electrical and Electronic Engineers (IEEE-1394), and thus the present invention has the following advantages:

1. An equal timing process is provided for a real time audio and video signal process.

2. The transmission speed has attained to a value of 400 MHz.

3. The present invention can be used immediately as the device is plug-in.

4. Instructions of different timing can be transferred to be used in the home audio and video interoperability and the time equaling process which is preferred to the other interface.

5. The present invention can be used widely in consumers electronic products and industrial electronic products.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A home network connection system, wherein a plurality of 1394 signal connecting wires are connected to a plurality of plug boxes and a plurality of electronic and electric devices; according to the home audio and video interoperability (HAVI) communication protocol installed in said 1394 signal transformation devices, said plurality of electronic and electric devices connected to said 1394 signal connecting wires are controlled through said 1394 signal transformation devices; said plurality of 1394 signal transformation devices are installed in a space and are connected to devices through said 1394 signal connecting wires for controlling said plurality of electronic and electric devices; characterized in that said electronic and electric devices are assembled as a complete network system, and then through connections of said 1394 signal transformation devices and according to the 1394 communication protocol, resources in said electronic and electric devices are shared by other member.

2. The home network connection system as claimed in claim 1, wherein the home audio and video interoperability which is an industrial standard of consumer's electronic product for communicating electronic devices from different manufacturer, the home network connection system is used independent of initiating systems or central processing units (CPU) or working platforms used in work station.

3. The home network connection system as claimed in claim 1, wherein the plurality of electronic and electric devices are 3C (computer, communication and consumer) electronic products.

4. The home network connection system as claimed in claim 3, wherein the 3C electronic and electric device is selected from one of a group containing a television, a computer, an electromagnetic oven, a microwave oven, a projector, and a telephone.

5. The home network connection system as claimed in claim 1, wherein said 1394 signal transformation device is installed with a plurality of signal slots for being connected by said 1394 signal connecting wires.

6. The home network connection system as claimed in claim 1, wherein a wave repeater is installed in said 1394 signal transformation device for amplifying received signal.

7. The home network connection system as claimed in claim 1, wherein said plurality of 1394 signal transformation devices are connected with each other through signal connecting wires; said 1394 signal transformation devices are installed in a space for transferring control signals of said plurality of devices connected to said 1394 signal transformation devices through said 1394 signal wires.

8. The home network connection system as claimed in claim 6 or 7, wherein amplified signals through said wave repeater in said 1394 signal transformation device is transferred through said 1394 signal connecting wires between said 1394 signal transformation devices.

9. The home network connection system as claimed in claim 1, wherein a equal timing process is provided for a real time audio and video signal process.

10. The home network connection system as claimed in claim 1, wherein the transmission speed of the 1394 signal is 400 MHz.

11. The home network connection system as claimed in claim 1, wherein the 1394 signal transformation device supports the function of real time as wires are connected.
